(19) United States
(12) Patent Application Publication
(10) Pub. No.: US 2021/0304651 A1
(43) Pub. Date: Sep. 30, 2021

(54) POWER SUPPLY CONTROL CIRCUIT, POWER SUPPLY CONTROL METHOD AND DISPLAY DEVICE

(71) Applicants: CHENGDU BOE OPTOELECTRONICS TECHNOLOGY CO., LTD., Chengdu, Sichuan (CN); BOE TECHNOLOGY GROUP CO., LTD., Beijing (CN)

(72) Inventors: Chienpang HUANG, Beijing (CN); Linchang HE, Beijing (CN); Changbo LIU, Beijing (CN)

(21) Appl. No.: 16/973,752

(22) PCT Filed: May 14, 2020
(86) PCT No.: PCT/CN2020/090278

§ 371 Date: Dec. 9, 2020

(30) Foreign Application Priority Data
Jun. 14, 2019 (CN) 201910515531.7

(51) Int. Cl. G09G 3/20; G05F 1/56

(52) U.S. Cl. CPC G09G 3/20; G09G 2330/021; G09G 2300/0426; G05F 1/56

(57) ABSTRACT

A power supply control circuit, a power supply control method and a display device are provided, the power supply control circuit is used for supplying power for display panel. A first power input end of the power supply control circuit is electrically connected to a power output end of a power management integrated circuit (PMIC), a second power input end of the power supply control circuit is electrically connected to a power output end of a driving integrated circuit (DDIC), and a power output end of the power supply control circuit is electrically connected to a power receiving end of the display panel.

### CROSS REFERENCE OF RELATED APPLICATION

The present application claims a priority of Chinese patent application No. 201910515531.7 filed on Jun. 14, 2019, which is incorporated herein by reference in its entirety.

### TECHNICAL FIELD

The present disclosure relates to the field of display technologies, and in particular, to a power supply control circuit, a power supply control method and a display device.

### BACKGROUND

At present, many display devices are only used for viewing time and notification messages when the screen is turned on, and at this time, if the whole screen is turned on for display, the power consumption is high, so that the display devices has an Always On Display (AOD) function, that is, the time, the notification messages and other contents are displayed in a partial area of the screen without turning on the whole screen, and thus the power consumption of the display devices may be greatly reduced. However, some display devices occupy system resources of the display device in order to implement the AOD function.

### SUMMARY

In a first aspect, a power supply control circuit is provided in an embodiment of the present disclosure, configured to supply power to a display panel, where a first power input end of the power supply control circuit is electrically connected to a power output end of a power management integrated circuit (PMIC), a second power input end of the power supply control circuit is electrically connected to a power output end of a driving integrated circuit (DDIC), and a power output end of the power supply control circuit is electrically connected to a power receiving end of the display panel;

the power supply control circuit is configured to, in a case that the power output end of the PMIC outputs a first display voltage, receive the first display voltage, and transmit the first display voltage to the display panel, to enable the display panel to display in a screen-on mode;

the power supply control circuit is configured to, in a case that the power output end of the PMIC does not output a first display voltage, receive a second display voltage output by the power output end of the DDIC, and transmit the second display voltage to the display panel, to enable the display panel to display in a screen-off mode.

The power output end of the PMIC includes a first high-level signal output end and a first low-level signal output end;

the power output end of the DDIC includes a second high-level signal output end and a second low-level signal output end;

the power receiving end of the display panel includes a high-level signal receiving end and a low-level signal receiving end;

the first display voltage includes a first high-level signal and a first low-level signal, and the second display voltage includes a second high-level signal and a second low-level signal;

the power supply control circuit includes a first control sub-circuit and a second control sub-circuit;

in the case that the power output end of the PMIC outputs the first display voltage, the first control sub-circuit receives the first high-level signal from the first high-level signal output end and transmits the first high-level signal to the high-level signal receiving end, and the second control sub-circuit receives the first low-level signal from the first low-level signal output end and transmits the first low-level signal to the low-level signal receiving end, to enable the display panel to display in the screen-on mode;

in the case that the power output end of the PMIC does not output the first display voltage and the DDIC outputs the second display voltage, the first control sub-circuit receives the second high-level signal from the second high-level signal output end and transmits the second high-level signal to the high-level signal receiving end, and the second control sub-circuit receives the second low-level signal from the second low-level signal output end and transmits the second low-level signal to the low-level signal receiving end, to enable the display panel to display in the screen-off mode.

Further, the first control sub-circuit includes a first transistor and a second transistor;

a first electrode of the first transistor is electrically connected to a high-level signal output end of the PMIC, a second electrode of the first transistor is electrically connected to the high-level signal receiving end of the display panel, and a control electrode of the first transistor is electrically connected to a high-level signal output end of the DDIC;

a first electrode of the second transistor is electrically connected to the high-level signal output end of the DDIC, a second electrode of the second transistor is electrically connected to a grounding end, and a control electrode of the second transistor is electrically connected to the high-level signal output end of the PMIC.

Further, the first control sub-circuit further includes a first resistor, one end of the first resistor is connected to the control electrode of the first transistor, the other end of the first resistor is connected to the second electrode of the first transistor.

Further, the second control sub-circuit includes a third transistor and a fourth transistor;

a first electrode of the third transistor is electrically connected to a low-level signal output end of the PMIC, a second electrode of the third transistor is electrically connected to the low-level signal receiving end of the display panel, and a control electrode of the third transistor is electrically connected to a low-level signal output end of the DDIC;

a first electrode of the fourth transistor is electrically connected to the low-level signal output end of the DDIC, a second electrode of the fourth transistor is electrically connected to the high-level signal output end of the DDIC, and a control electrode of the fourth transistor is electrically connected to the grounding end.

Further, the second control sub-circuit further includes a second resistor, one end of the second resistor is connected to the control electrode of the third transistor, the other end of the second resistor is connected to the second electrode of the third transistor.

In a second aspect, a power supply control method is further provided in an embodiment of the present disclosure, applied to the power supply control circuit above and including:

in a case that the power output end of the PMIC outputs a first display voltage, the power supply control circuit receiving the first display voltage and transmitting the first display voltage to the display panel, to enable the display panel to display in a screen-on mode;

in a case that the power output end of the PMIC does not output a first display voltage, the power supply control circuit receiving a second display voltage output by the power output end of the DDIC and transmitting the second display voltage to the display panel, to enable the display panel to display in a screen-off mode.

In a third aspect, a display device is further provided in an embodiment of the present disclosure, including a PMIC, a DDIC and a display panel, where the display device further includes the power supply control circuit hereinabove.

Further, a control end of the DDIC is connected to the power output end of the PMIC;

the DDIC is configured to, in a case that the power output end of the PMIC does not output a first display voltage, output a second display voltage through the power output end of the DDIC.

### BRIEF DESCRIPTION OF THE DRAWINGS

In order to more clearly illustrate the technical solutions of the embodiments of the present disclosure, the drawings required to be used in the description of the embodiments of the present disclosure will be briefly introduced below, and it is apparent that the drawings in the following description are only some embodiments of the present disclosure, and it is obvious for those skilled in the art that other drawings may be obtained according to the drawings without inventive work.

FIG. 1 is a circuit diagram of a power supply control circuit transmitting a high-level signal in the related art;

FIG. 2 is a circuit diagram of a power supply control circuit transmitting a low-level signal in the related art;

FIG. 3 is a schematic view of a display device according to an embodiment of the disclosure;

FIG. 4 is a circuit diagram of a first control circuit in a power supply control circuit according to an embodiment of the disclosure;

FIG. 5 is a circuit diagram of a second control circuit in a power supply control circuit according to an embodiment of the disclosure; and

FIG. 6 is a flowchart of a power supply control method according to an embodiment of the disclosure.

### DETAILED DESCRIPTION

The technical solutions in the embodiments of the present disclosure will be described clearly and completely with reference to the drawings in the embodiments of the present disclosure, and it is to be understood that the described embodiments are only some embodiments, but not all embodiments, of the present disclosure. All other embodiments, which can be derived by a person skilled in the art from the embodiments disclosed herein without inventive work, are intended to be within the scope of the present disclosure.

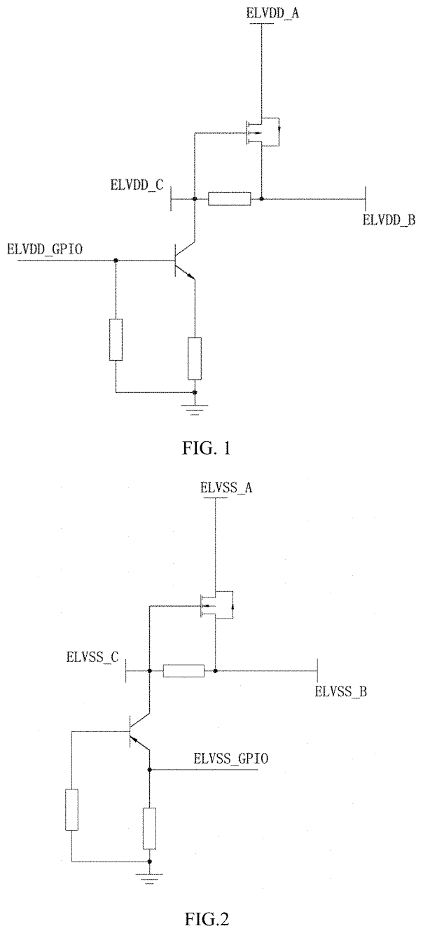

In the related art, only some models of Power Management Integrated Circuits (PMICs) support the AOD function, and when the PMICs in the display device do not support the AOD function, external circuits are added to the display device to support the AOD function, as shown in FIG. 1 and FIG. 2, a Controller (CPU) of the display device is required to be used as switches of the external circuits, which occupies system resources of the display device. Specifically, ELVDD GPIO in FIG. 1 is a high-level control signal output end of the CPU, ELVSS GPIO in FIG. 2 is a low-level control signal output end of the CPU, and the external circuit in FIG. 1 and FIG. 2 needs to switch the voltage required for the screen-on display mode or screen-off display mode to the display panel based on the signals output by the high-level control signal output end and the low-level control signal output end of the CPU.

The present disclosure provides a power supply control circuit, a power supply control method, and a display device, to solve the problem that when a PMIC inside a display device in the related art does not support an AOD function, an external circuit for supporting the AOD function needs to occupy system resources of the display device.

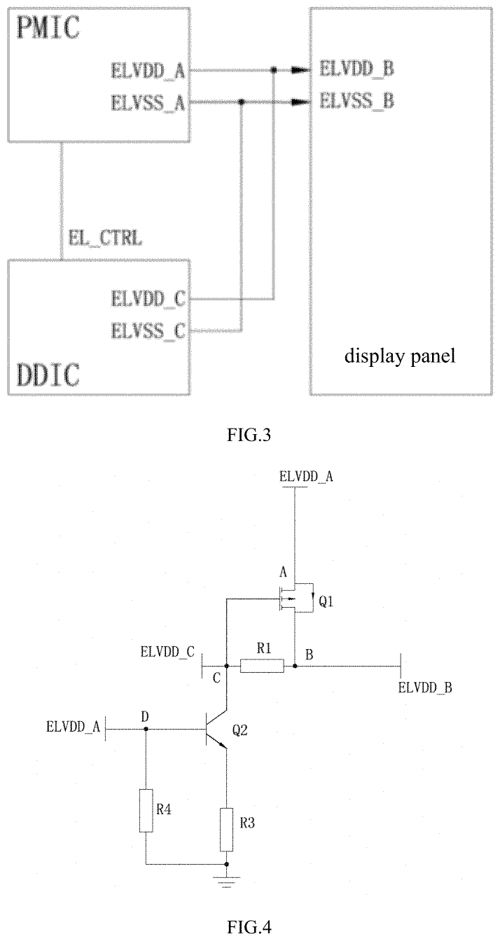

The embodiment of the present disclosure provides a power supply control circuit, configured to supply power to a display panel, as shown in FIG. 3, a first power input end of the power supply control circuit is electrically connected to a power output end of a PMIC, a second power input end of the power supply control circuit is electrically connected to a power output end of a DDIC, and a power output end of the power supply control circuit is electrically connected to a power receiving end of the display panel;

the power supply control circuit is configured to, in a case that the power output end of the PMIC outputs a first display voltage, receive the first display voltage, and transmit the first display voltage to the display panel, to enable the display panel to display in a screen-on mode;

the power supply control circuit is configured to, in a case that the power output end of the PMIC does not output a first display voltage, receive a second display voltage output by the power output end of the DDIC, and transmit the second display voltage to the display panel, to enable the display panel to display in a screen-off mode.

In the embodiment of the disclosure, the power supply control circuit may take that whether the PMIC outputs the first display voltage as a basis for switching the display panel between the screen-on display mode and the screen-off display mode, does not need to be connected to a controller of the display device, that is, system resources of the display device are not occupied, and system resources of the display device can be saved on the premise of ensuring normal work of the AOD function. Therefore, the technical scheme provided by the disclosure may save system resources of the display device on the premise of ensuring the normal work of the AOD function.

The display panel may be a liquid crystal display panel, an Organic Light-Emitting Diode (OLED) display panel, a quantum dot display panel, or the like, and the embodiment of the disclosure does not limit the specific kind of the display panel.

The PMIC is a power management integrated circuit of the display device, and can take on the roles of conversion, distribution, detection and other power management of the power in the whole operation process of the display device. In the embodiment of the present disclosure, the PMIC may provide a voltage required for the screen-on display mode of the display panel, that is, the entire display panel emits light.

The first power input end of the power supply control circuit is connected to the power output end of the PMIC, and when the power output end of the PMIC outputs the first display voltage, the power supply control circuit transmits the first display voltage to the display panel.

The DDIC is a driving circuit in the imaging system of the display device, and can be responsible for driving the display panel and controlling the driving current, and the DDIC can drive the display panel in single color, double color and full color modes to emit light for display. In the embodiment of the disclosure, the DDIC can provide the voltage required for the display panel to display in a screen-off mode, i.e. a part of region of the display panel emits light to display, and the rest of the region of the display panel are turned off.

The second power input end of the power supply control circuit is electrically connected to the power output end of the DDIC. When the power output end of the PMIC does not output the first display voltage, the power supply control circuit transmits the second display voltage provided by the DDIC to the display panel.

The DDIC may continuously provide the second display voltage, and the power supply control circuit may transmit the second display voltage to the display panel when the first display voltage is not output from the power output end of the PMIC; alternatively, the DDIC may be connected to the PMIC and detect whether the PMIC outputs the first display voltage, as shown in FIG. 3, the DDIC outputs the second display voltage only when the PMIC does not output the first display voltage, so that the power supply control circuit transmits the second display voltage to the display panel when the power output end of the PMIC does not output the first display voltage. The scheme shown in FIG. 3 can reduce the power consumption of the display device, and the specific structure will be described later with the scheme shown in FIG. 3.

The power output end of the PMIC includes a first high-level signal output end and a first low-level signal output end;

the power output end of the DDIC includes a second high-level signal output end and a second low-level signal output end;

the power receiving end of the display panel includes a high-level signal receiving end and a low-level signal receiving end;

the first display voltage includes a first high-level signal and a first low-level signal, and the second display voltage includes a second high-level signal and a second low-level signal;

the power supply control circuit includes a first control sub-circuit and a second control sub-circuit;

in the case that the power output end of the PMIC outputs the first display voltage, the first control sub-circuit receives the first high-level signal from the first high-level signal output end and transmits the first high-level signal to the high-level signal receiving end, and the second control sub-circuit receives the first low-level signal from the first low-level signal output end and transmits the first low-level signal to the low-level signal receiving end, to enable the display panel to display in the screen-on mode;

in the case that the power output end of the PMIC does not output the first display voltage and the DDIC outputs the second display voltage, the first control sub-circuit receives the second high-level signal from the second high-level signal output end and transmits the second high-level signal to the high-level signal receiving end, and the second control sub-circuit receives the second low-level signal from the second low-level signal output end and transmits the second low-level signal to the low-level signal receiving end, to enable the display panel to display in the screen-off mode.

When the first control sub-circuit is configured to transmit a first high-level signal, the second control sub-circuit is configured to transmit a first low-level signal; when the first control sub-circuit is configured to transmit a second high-level signal, the second control sub-circuit is configured to transmit a second low-level signal.

In this embodiment, the first control sub-circuit and the second control sub-circuit cooperate to jointly complete transmission of the first display voltage or the second display voltage, so as to ensure that the display panel can normally display.

A first input end of the first control sub-circuit is electrically connected to a first high-level signal output end of the PMIC, a second input end of the first control sub-circuit is electrically connected to a second high-level signal output end of the DDIC, and an output end of the first control sub-circuit is electrically connected to a high-level signal receiving end of the display panel;

the first input end of the second control sub-circuit is electrically connected to the first low-level signal output end of the PMIC, the second input end of the second control sub-circuit is electrically connected to the second low-level signal output end of the DDIC, and the output end of the second control sub-circuit is connected to the low-level signal receiving end of the display panel.

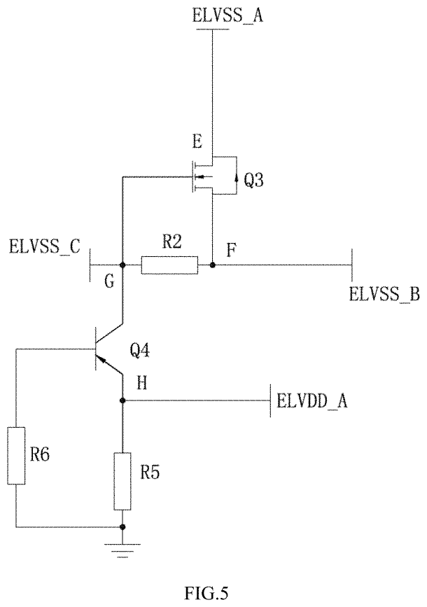

Further, as shown in FIG. 4, the first control sub-circuit includes a first transistor Q1 and a second transistor Q2;

a first electrode of the first transistor Q1 is electrically connected to the high-level signal output end of the PMIC, a second electrode of the first transistor Q1 is electrically connected to the high-level signal receiving end of the display panel, and a control electrode of the first transistor Q1 is electrically connected to the high-level signal output end of the DDIC;

a first electrode of the second transistor Q2 is electrically connected to the high-level signal output end of the DDIC, a second electrode of the second transistor Q2 is electrically connected to a grounding end, and a control electrode of the second transistor Q2 is electrically connected to the high-level signal output end of the PMIC.

ELVDD_a in FIG. 4 and FIG. 5 is a high-level signal output end of PMIC, and ELVSS_a is a low-level signal output end of PMIC; ELVDD_B is a high-level signal receiving end of the display panel, and ELVSS_B is a low-level signal receiving end of the display panel; ELVDD_C is a high-level signal output end of the DDIC, and ELVSS_C is a low-level signal output end of the DDIC.

When the display panel is required to display in the screen-on mode, the high-level output end of the PMIC outputs a high-level signal and the high-level output end of the DDIC does not output a high-level signal, at this time, the potentials of the node A (the first electrode of the first transistor) and the node D (the control electrode of the second transistor) in FIG. 4 are at high potentials, and the potential of the node C (the control electrode of the first transistor) is 0V, so that the first transistor Q1 and the second transistor Q2 are turned on, the potential of the node B (the second electrode of the first transistor) is also at a high potential, and the high-level signal output by the PMIC is transmitted to the display panel.

When the display panel is required to display in the screen-off mode, the high-level output end of the PMIC does not output a high-level signal and the high-level output end of the DDIC outputs a high-level signal, at this time, the node A and the node D in FIG. 4 are 0V, which causes the first transistor Q1 and the second transistor Q2 to be turned off, the node B and the node C are at high potentials, and the high-level signal output by the DDIC is transmitted to the display panel.

The voltage value of the high-level signal may be between 3.5V and 5.5V, for example, 4.6V, but is not limited thereto.

Further, the first control sub-circuit may further include a first resistor R1, one end of the first resistor R1 is connected to the control electrode of the first transistor Q1, and the other end of the first resistor R1 is connected to the second electrode of the first transistor Q1.

The first resistor R1 is used to limit the current between node B and node C, and protect the display panel from large current. The resistance value of the first resistor R1 may be 100K Ω.

In addition, the first control sub-circuit may further include a third resistor R3 and a fourth resistor R4, one end of the third resistor R3 is connected to the second electrode of the second transistor Q2, and the other end of the third resistor R3 is connected to the grounding end; one end of the fourth resistor R4 is connected to the control electrode of the second transistor Q2, and the other end of the fourth resistor R4 is connected to the grounding end.

The resistance values of the third resistor R3 and the fourth resistor R4 may be 100K Ω.

Further, as shown in FIG. 5, the second control sub-circuit includes a third transistor Q3 and a fourth transistor Q4;

a first electrode of the third transistor Q3 is electrically connected to the low-level signal output end of the PMIC, a second electrode of the third transistor Q3 is electrically connected to the low-level signal receiving end of the display panel, and a control electrode of the third transistor Q3 is electrically connected to the low-level signal output end of the DDIC;

a first electrode of the fourth transistor Q4 is electrically connected to the low-level signal output end of the DDIC, a second electrode of the fourth transistor Q4 is electrically connected to the high-level signal output end of the DDIC, and a control electrode of the fourth transistor Q4 is electrically connected to a grounding end.

When the display panel is required to display in a screen-on mode, the high-level output end of the PMIC outputs a high-level signal, the low level output end of the PMIC outputs a low-level signal, and the low level output end of the DDIC does not output a low-level signal, at this time, in FIG. 5, the node E (the first electrode of the third transistor) is at a low potential, the node H (the second electrode of the fourth transistor) is at a high potential, and the fourth transistor Q4 is turned on, so that the potential of the node G (the control electrode of the third transistor) is 4.6V, and the third transistor Q3 is turned on, so that the potential of the node F (the second electrode of the third transistor) is also at a low potential, and the low-level signal output by the PMIC is transmitted to the display panel.

When the display panel is required to display in a screen-off mode, the high-level output end of the PMIC does not output a high-level signal, the low-level output end of the PMIC does not output a low-level signal, and the low-level output end of the DDIC outputs a low-level signal, at this time, the potentials of the node E and the node H in FIG. 5 are 0V, the third transistor Q3 and the fourth transistor Q4 are turned off, and the potentials of the node F and the node G are low potentials, so that the low-level signal output by the DDIC is transmitted to the display panel.

The voltage value of the low-level signal may be between −1.8V and −3.8V, for example, −2.4V, but not limited thereto.

Further, the second control sub-circuit further includes a second resistor R2, one end of the second resistor R2 is connected to the control electrode of the third transistor Q3, and the other end of the second resistor R2 is connected to the second electrode of the third transistor Q3.

The second resistor R2 is used to limit the current between node F and node G, and protect the display panel from large current. The resistance value of the second resistor R2 may be 100K Ω.

In addition, the second control sub-circuit may further include a fifth resistor R5 and a sixth resistor R6, one end of the fifth resistor R5 is connected to the second electrode of the fourth transistor Q4, and the other end of the fifth resistor R5 is connected to the grounding end; one end of the sixth resistor R6 is connected to the control electrode of the fourth transistor Q4, and the other end of the sixth resistor R6 is connected to the grounding end.

The resistance values of the fifth resistor R5 and the sixth resistor R6 may be 100K Ω.

The transistors (Q1 to Q4) may be transistors, thin film transistors, field effect transistors, or other devices having the same characteristics, where one of the two electrodes is referred to as a first electrode and the other is referred to as a second electrode to distinguish the two electrodes of the transistors except for the control electrode.

In practical operation, when the transistor is a triode, the control electrode may be a base electrode, the first electrode may be a collector electrode, and the second electrode may be an emitter electrode; alternatively, the control electrode may be a base electrode, the first electrode may be an emitter electrode, and the second electrode may be a collector electrode.

In practical operation, when the transistor is a thin film transistor or a field effect transistor, the control electrode may be a gate electrode, the first electrode may be a drain electrode, and the second electrode may be a source electrode; alternatively, the control electrode may be a gate electrode, the first electrode may be a source electrode, and the second electrode may be a drain electrode.

For example: the first transistor Q1 in FIG. 4 may be a P-type fet (the first electrode of the first transistor Q1 is the source, the second electrode of the first transistor Q1 is the drain), the second transistor Q2 may be an NPN-type transistor (the first electrode of the second transistor Q2 is the collector, and the second electrode of the second transistor Q2 is the emitter); another example is: the third transistor Q3 in FIG. 5 may be an N-type fet (the first electrode of the first transistor Q1 is the drain, and the second electrode of the first transistor Q1 is the source), and the fourth transistor Q4 may be a PNP transistor (the first electrode of the second transistor Q2 is the emitter, and the second electrode of the second transistor Q2 is the collector).

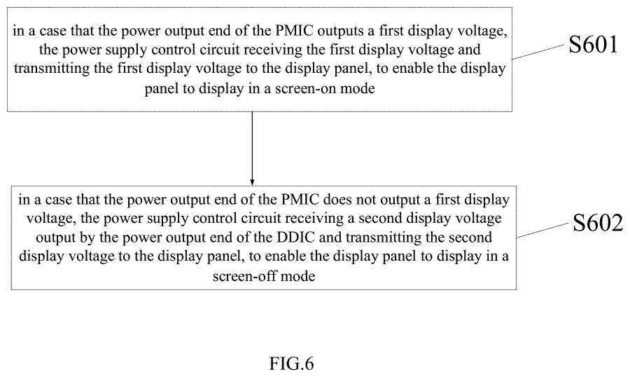

An embodiment of the present disclosure further provides a power supply control method, which is applied to the power supply control circuit described above, and as shown in FIG. 6, the method includes:

step 601: in a case that the power output end of the PMIC outputs a first display voltage, the power supply control circuit receiving the first display voltage and transmitting the first display voltage to the display panel, to enable the display panel to display in a screen-on mode;

step 602: in a case that the power output end of the PMIC does not output a first display voltage, the power supply control circuit receiving a second display voltage output by the power output end of the DDIC and transmitting the second display voltage to the display panel, to enable the display panel to display in a screen-off mode.

In the embodiment of the disclosure, the power supply control circuit may take that whether the PMIC outputs the first display voltage as a basis for switching the display panel between the screen-on display mode and the screen-off display mode, does not need to be connected to a controller of the display device, that is, system resources of the display device are not occupied, and system resources of the display device can be saved on the premise of ensuring normal work of the AOD function. Therefore, the technical scheme provided by the disclosure may save system resources of the display device on the premise of ensuring the normal work of the AOD function.

The display panel may be a liquid crystal display panel, an Organic Light-Emitting Diode (OLED) display panel, a quantum dot display panel, or the like, and the embodiment of the disclosure does not limit the specific kind of the display panel.

The PMIC is a power management integrated circuit of the display device, and can take on the roles of conversion, distribution, detection and other power management of the power in the whole operation process of the display device. In the embodiment of the present disclosure, the PMIC may provide a voltage required for the screen-on display mode of the display panel, that is, the entire display panel emits light.

The first power input end of the power supply control circuit is connected to the power output end of the PMIC, and when the power output end of the PMIC outputs the first display voltage, the power supply control circuit transmits the first display voltage to the display panel.

The DDIC is a driving circuit in the imaging system of the display device, and can be responsible for driving the display panel and controlling the driving current, and the DDIC can drive the display panel in single color, double color and full color modes to emit light for display. In the embodiment of the disclosure, the DDIC can provide the voltage required for the display panel to display in a screen-off mode, i.e. a part of region of the display panel emits light to display, and the rest of the region of the display panel are turned off.

The second power input end of the power supply control circuit is electrically connected to the power output end of the DDIC. When the power output end of the PMIC does not output the first display voltage, the power supply control circuit transmits the second display voltage provided by the DDIC to the display panel.

The DDIC may continuously provide the second display voltage, and the power supply control circuit may transmit the second display voltage to the display panel when the first display voltage is not output from the power output end of the PMIC; alternatively, the DDIC may be connected to the PMIC and detect whether the PMIC outputs the first display voltage, as shown in FIG. 3, the DDIC outputs the second display voltage only when the PMIC does not output the first display voltage, so that the power supply control circuit transmits the second display voltage to the display panel when the power output end of the PMIC does not output the first display voltage. The scheme shown in FIG. 3 can reduce the power consumption of the display device, and the specific structure will be described later with the scheme shown in FIG. 3

The embodiment of the present disclosure further provides a display device, which includes a power management integrated circuit (PMIC), a driving integrated circuit (DDIC) and a display panel, and the display device further includes the power supply control circuit as described above.

The display device may be a display, a mobile phone, a tablet computer, a television, a wearable electronic device, a navigation display device, or the like.

Since the structure of the display device body is the prior art, and the structure of the power supply control circuit is described in detail in the above embodiment, the specific structure of the power supply control circuit is not described in detail in this embodiment.

Further, a control end of the DDIC is connected to a power output end of the PMIC;

the DDIC is configured to output a second display voltage through the power output end of the DDIC when the power output end of the PMIC does not output the first display voltage.

In this embodiment, the DDIC may detect whether the PMIC outputs the first display voltage, and the DDIC does not output the second display voltage when the PMIC outputs the first display voltage; the DDIC outputs a second display voltage when the PMIC does not output the first display voltage.

By not outputting the second display voltage when the PMIC outputs the first display voltage, unnecessary energy loss can be saved, the power consumption of the display device can be reduced, and standby time of the display device using the battery can be prolonged.

Unless defined otherwise, technical or scientific terms used herein shall have the ordinary meaning as understood by one of ordinary skill in the art to which this disclosure belongs. The use of “first,” “second,” and the like in this disclosure is not intended to indicate any order, quantity, or importance, but rather is used to distinguish one element from another. The word “comprising” or “comprises”, and the like, means that the element or item preceding the word comprises the element or item listed after the word and its equivalent, but does not exclude other elements or items. The terms “connected” or “coupled” and the like are not restricted to physical or mechanical connections, but may include electrical connections, whether direct or indirect. “Upper”, “lower”, “left”, “right”, and the like are used only to indicate relative positional relationships, and when the absolute position of the object being described is changed, the relative positional relationships may also be changed accordingly.

It will be understood that when an element such as a layer, film, region or substrate is referred to as being “on” or “under” another element, it can be “directly on” or “under” the other element or intervening elements may be present.

While the embodiments of the present disclosure have been described in connection with the drawings, the present disclosure is not limited to the embodiments, which have been described above for illustrative purposes only and not for purposes of limitation, and it will be appreciated by those of ordinary skill in the art that, in light of the present disclosure, numerous modifications may be made without departing from the principle of the disclosure and the scope of the claims.

1. A power supply control circuit, configured to supply power to a display panel, wherein a first power input end of the power supply control circuit is electrically connected to a power output end of a power management integrated circuit (PMIC), a second power input end of the power supply control circuit is electrically connected to a power output end of a driving integrated circuit (DDIC), and a power output end of the power supply control circuit is electrically connected to a power receiving end of the display panel;
the power supply control circuit is configured to, in a case that the power output end of the PMIC outputs a first display voltage, receive the first display voltage, and transmit the first display voltage to the display panel, to enable the display panel to display in a screen-on mode;
the power supply control circuit is configured to, in a case that the power output end of the PMIC does not output a first display voltage, receive a second display voltage output by the power output end of the DDIC, and transmit the second display voltage to the display panel, to enable the display panel to display in a screen-off mode.

2. The power supply control circuit according to claim 1, wherein the power output end of the PMIC comprises a first high-level signal output end and a first low-level signal output end;
the power output end of the DDIC comprises a second high-level signal output end and a second low-level signal output end;
the power receiving end of the display panel comprises a high-level signal receiving end and a low-level signal receiving end;
the first display voltage comprises a first high-level signal and a first low-level signal, and the second display voltage comprises a second high-level signal and a second low-level signal;
the power supply control circuit comprises a first control sub-circuit and a second control sub-circuit;
in the case that the power output end of the PMIC outputs the first display voltage, the first control sub-circuit receives the first high-level signal from the first high-level signal output end and transmits the first high-level signal to the high-level signal receiving end, and the second control sub-circuit receives the first low-level signal from the first low-level signal output end and transmits the first low-level signal to the low-level signal receiving end, to enable the display panel to display in the screen-on mode;
in the case that the power output end of the PMIC does not output the first display voltage and the DDIC outputs the second display voltage, the first control sub-circuit receives the second high-level signal from the second high-level signal output end and transmits the second high-level signal to the high-level signal receiving end, and the second control sub-circuit receives the second low-level signal from the second low-level signal output end and transmits the second low-level signal to the low-level signal receiving end, to enable the display panel to display in the screen-off mode.

3. The power supply control circuit according to claim 2, wherein the first control sub-circuit comprises a first transistor and a second transistor;
a first electrode of the first transistor is electrically connected to a high-level signal output end of the PMIC, a second electrode of the first transistor is electrically connected to the high-level signal receiving end of the display panel, and a control electrode of the first transistor is electrically connected to a high-level signal output end of the DDIC;
a first electrode of the second transistor is electrically connected to the high-level signal output end of the DDIC, a second electrode of the second transistor is electrically connected to a grounding end, and a control electrode of the second transistor is electrically connected to the high-level signal output end of the PMIC.

4. The power supply control circuit according to claim 3, wherein the first control sub-circuit further comprises a first resistor, one end of the first resistor is connected to the control electrode of the first transistor, the other end of the first resistor is connected to the second electrode of the first transistor.

5. The power supply control circuit according to claim 2, wherein the second control sub-circuit comprises a third transistor and a fourth transistor;
a first electrode of the third transistor is electrically connected to a low-level signal output end of the PMIC, a second electrode of the third transistor is electrically connected to the low-level signal receiving end of the display panel, and a control electrode of the third transistor is electrically connected to a low-level signal output end of the DDIC;
a first electrode of the fourth transistor is electrically connected to the low-level signal output end of the DDIC, a second electrode of the fourth transistor is electrically connected to the high-level signal output end of the DDIC, and a control electrode of the fourth transistor is electrically connected to the grounding end.

6. The power supply control circuit according to claim 5, wherein the second control sub-circuit further comprises a second resistor, one end of the second resistor is connected to the control electrode of the third transistor, the other end of the second resistor is connected to the second electrode of the third transistor.

7. The power supply control circuit according to claim 1 wherein the PMIC does not support displaying in the screen-off mode.

8. The power supply control circuit according to claim 3, wherein the second control sub-circuit comprises a third transistor and a fourth transistor;
a first electrode of the third transistor is electrically connected to a low-level signal output end of the PMIC, a second electrode of the third transistor is electrically connected to the low-level signal receiving end of the display panel, and a control electrode of the third transistor is electrically connected to a low-level signal output end of the DDIC;
a first electrode of the fourth transistor is electrically connected to the low-level signal output end of the DDIC, a second electrode of the fourth transistor is electrically connected to the high-level signal output end of the DDIC, and the control electrode of the fourth transistor is electrically connected to the grounding end.

9. The power supply control circuit according to claim 8, wherein the first control sub-circuit further comprises a first resistor, one end of the first resistor is connected to the control electrode of the first transistor, the other end of the first resistor is connected to the second electrode of the first transistor;
the second control sub-circuit further comprises a second resistor, one end of the second resistor is connected to the control electrode of the third transistor, and the other end of the second resistor is connected to the second electrode of the third transistor.

10. The power supply control circuit according to claim 9, wherein the first control sub-circuit further comprises a third resistor and a fourth resistor, one end of the third resistor is connected to the second electrode of the second transistor, and the other end of the third resistor is connected to the grounding end; one end of the fourth resistor is connected to the control electrode of the second transistor, and the other end of the fourth resistor is connected to the grounding end.

11. The power supply control circuit according to claim 10, wherein the second control sub-circuit further comprises a fifth resistor and a sixth resistor, one end of the fifth resistor is connected to the second electrode of the fourth transistor, and the other end of the fifth resistor is connected to the grounding end; one end of the sixth resistor is connected to the control electrode of the fourth transistor, and the other end of the sixth resistor is connected to the grounding end.

12. A power supply control method, applied to the power supply control circuit according to claim 1 and comprising:
in a case that the power output end of the PMIC outputs a first display voltage, the power supply control circuit receiving the first display voltage and transmitting the first display voltage to the display panel, to enable the display panel to display in a screen-on mode;
in a case that the power output end of the PMIC does not output a first display voltage, the power supply control circuit receiving a second display voltage output by the power output end of the DDIC and transmitting the second display voltage to the display panel, to enable the display panel to display in a screen-off mode.

13. A display device, comprising a power management integrated circuit (PMIC), a driving integrated circuit (DDIC) and a display panel, wherein the display device further comprises the power supply control circuit according to claim 1.

14. The display device according to claim 13, wherein a control end of the DDIC is connected to the power output end of the PMIC;
the DDIC is configured to, in a case that the power output end of the PMIC does not output a first display voltage, output a second display voltage through the power output end of the DDIC.
